(19) United States
(12) Patent Application Publication
(10) Pub. No.: US 2020/0370293 A1
(43) Pub. Date: Nov. 26, 2020

(54) TRANSPARENT SOUND ABSORBING PANELS

(71) Applicant: CORNING INCORPORATED, Corning, NY (US)

(72) Inventors: Nicholas Francis Borrelli, Elmira, NY (US); Zhiqiang Shi, Shrewsbury, MA (US)

(21) Appl. No.: 16/992,370

(22) Filed: Aug. 13, 2020

Related U.S. Application Data
(63) Continuation of application No. 14/660,230, filed on Mar. 17, 2015, now abandoned.
(60) Provisional application No. 61/968,135, filed on Mar. 20, 2014.

(51) Int. Cl. E04B 1/84; C03C 23/00; C03C 3/095; C03C 10/00; C03C 4/04; C03C 15/00

(52) U.S. Cl. CPC E04B 1/84; C03C 23/007; C03C 3/095; E04B 9/001; C03C 4/04; C03C 23/002; C03C 15/00; C03C 10/0027

(57) ABSTRACT

A sound absorbing panel and method therefor comprising providing a first sheet of photosensitive material, applying a first mask having a first plurality of features to the first sheet of photosensitive material, exposing the masked material to ultraviolet light, heating the first sheet of photosensitive material to form crystals in exposed portions of the first sheet, and etching the crystals to form a second plurality of features in the first sheet of photosensitive material.

### CROSS-REFERENCE TO RELATED APPLICATIONS

This application is a continuation of U.S. patent application Ser. No. 14/660,230 filed on Mar. 17, 2015, the content of which claims the benefit of priority under 35 U.S.C. § 119 of U.S. Provisional Application Ser. No. 61/968,135 filed on Mar. 20, 2014 the content of each of which is relied upon and incorporated herein by reference in its entirety.

### BACKGROUND

In various types of indoor or outdoor environments, such as offices, reception or production halls, healthcare facilities and hospitals, sports halls and swimming pools, classrooms, and the like, it can be desirable and statutorily regulated, to provide acoustic conditions to the environment. Acoustic conditions can be described by reverberation, and to control this, sound absorbing elements are conventionally used, such as sound absorbing panels attached to walls, ceilings, and other surfaces.

Sound absorbing panels as surfaces for attachment to indoor walls and ceilings can use various physical effects for the absorption of sound. Some conventional sound absorbing panels include fiber-based absorbents comprising porous panels of mineral fibers (rock and glass wool) that act to dampen sound as the sound waves penetrate into the panel. These conventional panels reduce the energy of the sound waves by viscous losses in pores or structures of the panel. Some conventional sound absorbing panels include structures based on the Helmholtz resonator principle. Such panels generally include slits or apertures as well as fiber fabric (with or without mats) or porous fiber materials behind the panel to obtain satisfactory absorption.

Such conventional sound absorbing panels provide several disadvantages. For example, upon damage or wear such conventional panels can produce fibers to the environment. As these fibers are often made of melted glass or rock, any airborne fibers can irritate the respiratory passages of persons in the surrounding environment. Additionally, these fibers can limit the appearance of such panels as it can be difficult to keep them clean as they require minimum use of moisture when cleaning, and problems related to mold can arise in exterior paneling or locations exposed to moisture (e.g., swimming pools or the like).

Microperforated panels can obviate the disadvantages of conventional fiber panels; however, conventional microperforated panels and foils are produced by rolling a tool having a plurality of many small spikes over the surface of the panel. Other methods of producing microperforated panels, such as laser cutting and plastic moulding, are used for thicker panels but are not commercially viable for certain substrate materials, and certain hole depths and/or distributions.

Thus, there is a need in the industry to provide transparent sound absorbing panels capable of being utilized in interior and exterior environments without the disadvantages of conventional paneling. There is also a need for new sound absorbing panels that provide a clean and smooth surface that can be easily manufactured.

### SUMMARY

The disclosure generally relates to the sound absorbing panels using glass, glass ceramics, or other material for exterior and interior environments. Exemplary materials can be in some embodiments photosensitive. Thus, in some embodiments the photosensitive materials can be masked and patterned to form micro-perforations which act to dampen sound waves.

In some embodiments a method of making a sound absorbing panel is provided. The method can include providing a first sheet of photosensitive material, applying a first mask having a first plurality of features to the first sheet of photosensitive material, and exposing the masked material to ultraviolet light. The method also includes heating the first sheet of photosensitive material to form crystals in exposed portions of the first sheet and etching the crystals to form a second plurality of features in the first sheet of photosensitive material.

In other embodiments a sound absorbing panel is provided having a first sheet of photosensitive material and a resilient surface spaced apart from the first sheet of photosensitive material by a predetermined distance. The sheet of photosensitive material includes a first plurality of features etched therein, and the dimensions and distribution of the first plurality of features and the predetermined distance are determined as a function of sound aborptive characteristics of the panel.

In further embodiments, a sound absorbing panel is provided comprising a first sheet of photosensitive material and a resilient surface spaced apart from the first sheet of photosensitive material by a predetermined distance. The first sheet of photosensitive material can include a plurality of features formed therein without mechanical etching (i.e., formed by chemical etching or other means not including mechanical etching).

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description of various embodiments of the present disclosure, are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles, operations, and variations of the claimed subject matter.

### BRIEF DESCRIPTION OF THE DRAWINGS

These figures are provided for the purposes of illustration, it being understood that the embodiments disclosed and discussed herein are not limited to the arrangements and instrumentalities shown.

FIG. 1 is a block diagram of a method according to some embodiments.

FIGS. 2A and 2B are depictions of exemplary microperforated panel structures according to some embodiments and equivalent circuits.

FIG. 3A is an illustration of hole and etch variations according to some embodiments.

FIG. 3B is an illustration of non-limiting mask designs according to some embodiments.

FIGS. 4A and 4B are photographs of a microperforated sample according to some embodiments.

FIG. 5 is a series of plots illustrating acoustic absorption of some embodiments.

FIG. 6 is a plot of measured acoustic absorption between some embodiments, conventional glass and one inch foam.

FIGS. 7A and 7B are plots comparing experimental measurements of two embodiments with theoretical models.

FIG. 8 is a plot comparing measurements of acoustic absorption of additional embodiments as a function of perforation ratio.

FIG. 9 is a plot comparing measurements of acoustic absorption of further embodiments as a function of cavity depth.

While this description can include specifics for the purpose of illustration and understanding, these should not be construed as limitations on the scope, but rather as descriptions of features that can be including in and/or illustrative for particular embodiments.

### DETAILED DESCRIPTION

Various embodiments for transparent sound absorbing panels are described with reference to the figures, where like elements have been given like numerical designations to facilitate an understanding of the present disclosure.

In the following description, like reference characters designate like or corresponding parts throughout the several views shown in the figures. It also is understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, the group can comprise, consist essentially of, or consist of any number of those elements recited, either individually or in combination with each other.

Similarly, whenever a group is described as consisting of at least one of a group of elements or combinations thereof, the group can consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified

Those skilled in the art will recognize that many changes can be made to the embodiments described while still obtaining the beneficial results of the invention. It also will be apparent that some of the desired benefits of the present disclosure can be obtained by selecting some of the described features without using other features. Accordingly, those of ordinary skill in the art will recognize that many modifications and adaptations are possible and can even be desirable in certain circumstances and are part of the invention. Thus, the following description is provided as illustrative of the principles of the present disclosure and not in limitation thereof.

Those skilled in the art will appreciate that many modifications to the exemplary embodiments described herein are possible without departing from the spirit and scope of the invention. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

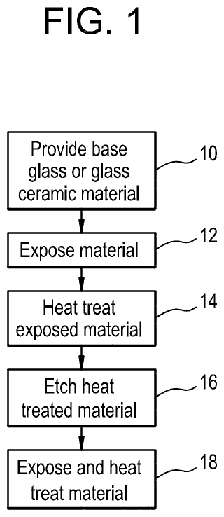

Embodiments of the present disclosure are generally directed to sound absorbing panels using photosensitive materials. Exemplary panels can be comprised of photosensitive glass or glass-ceramics (among other materials) and during the process of manufacture can be masked, exposed to ultraviolet (UV) radiation, and patterned to form sound absorbing features which can include micro-perforations, features or holes, which act to dampen sound wavefronts. It should be noted that the terms sound absorbing feature, perforation, feature, hole, channel and the plural forms thereof are utilized interchangeably in this disclosure; such use should not limit the scope of the claims appended herewith. Exemplary, non-limiting photosensitive materials can include a glass material or glass ceramic material having a main crystal phase comprising lithium disilicate Li₂Si₂O₅. FIG. 1 is a block diagram of a method according to some embodiments. With reference to FIG. 1, a base photosensitive glass or glass-ceramic can be melted and cast into a monolithic product, e.g., glass or glass-ceramic sheet, or thin film in step 10. In some examples, base photosensitive glasses and glass-ceramic materials can be derived from the SiO₂—Li₂O system. In some embodiments, the base photosensitive glass or glass-ceramic material can be produced in the form of a very thin film or sheet of a specific thickness (e.g., in the range from about 20 μm to about 2 mm). In additional embodiments, the sheet or film can be strengthened by various methods, including chemical strengthening (e.g., by ion-exchanging methods), thermally strengthened (e.g., by tempering or annealing) or otherwise strengthened to provide additional strength, scratch resistance or other suitable characteristics to an exemplary panel or structure. In some embodiments, the base photosensitive glass or glass-ceramic material can contain Ce³⁺- and Ag⁺-ions. Exemplary compositions include between about 75-85 wt % SiO₂, about 2-6 wt % Al₂O₃, about 7-11 wt % Li₂O, about 3-6 wt % K₂O, about 0.5-2.5 wt % Na₂O, about 0.01-0.5 wt % Ag, about 0.01-0.5 wt % Sb₂O₃, about 0.01-0.04 wt % CeO₂, about 0-0.01 wt % Au, and about 0-0.01 wt % SnO₂. In one embodiment, a composition can include about 79.6 wt % SiO₂, about 4.0 wt % Al₂O₃, about 9.3 wt % Li₂O, about 4.1 wt % K₂O, about 1.6 wt % Na₂O, about 0.11 wt % Ag, about 0.4 wt % Sb₂O₃, about 0.014 wt % CeO₂, about 0.001 wt % Au, and about 0.003 wt % SnO₂. Of course, these photosensitive compositions are exemplary only and should not limit the scope of the claims appended herewith as other photosensitive glass and glass ceramic compositions can be utilized.

The thin sheet or product can then be exposed to UV light using a mask at step 12. During exposure to UV light, photoelectrons can cause the oxidation of Ce³⁺ to Ce⁴⁺ in an exemplary composition, and as a result, Ag⁺ can be reduced to Ag⁰ using the following relationship: Ce³⁺+h·ν (312 nm)→Ce⁴⁺+e⁻; Ag⁺+e⁻ →Ag⁰. This metal colloid (e.g., metallic silver) can be the nucleating agent for a lithium metasilicate Li₂SiO₃ phase. As a result, this crystal phase can be precipitated by controlled crystallization at high temperatures, e.g., approximately 600° C. Thus, in some embodiments, the UV exposed product can be heat treated and lithium metasilicate crystals Li₂SiO₃ subsequently precipitated therefrom at step 14. The Li₂SiO₃ can then be etched at step 16. In some embodiments, the lithium metasilicate crystals can be etched with dilute hydrofluoric acid (HF) or another suitable etchant. Other etchants include, but are not limited to, potassium hydroxide, isopropyl alcohol, EDP (ethylenediamine pyrocatechol), tetramethylammonium hydroxide, phosphoric acid, acetic acid, nitric acid, hydrochloric acid, hydrogen peroxide, citric acid, sulfuric acid, ammonium fluoride, ceric ammonium nitrate, water, and combinations thereof. Of course, the type of etchant utilized in exemplary embodiments can be determined by the underlying substrate or material to be etched. In such a manner, defined structures or patterns can be easily etched into a finished product including sound absorbing features. In further embodiments, UV exposure and heat treatment can be conducted again at step 18 whereby approximately 40 wt % of the main crystal phase lithium disilicate can be produced along with α-quartz with a total crystal content of approximately 60%. Through such exemplary UV and masking techniques as well as subsequent etching step(s), embodiments according to the present disclosure can produce smaller and more intricate sound absorbing features (e.g., perforations, holes, channels, or the like), e.g., on the order of about 20 to 50 μm.

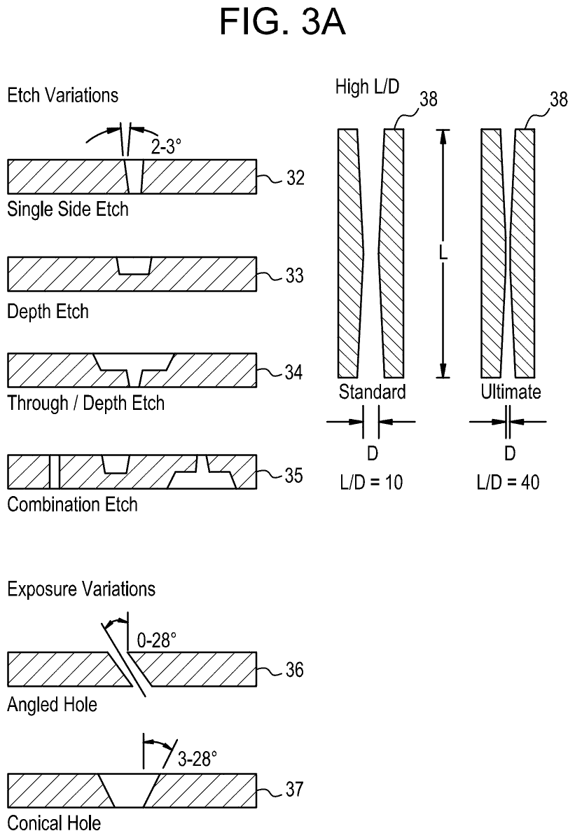

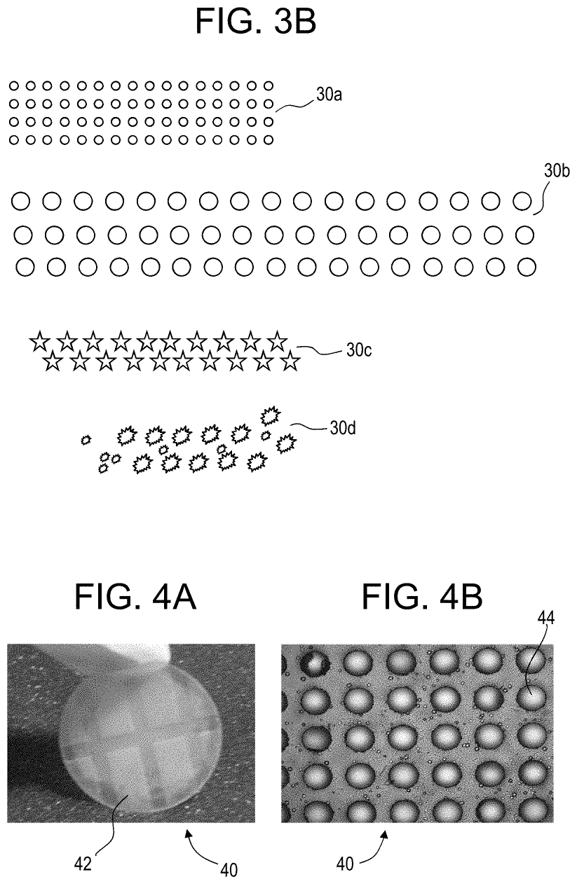

In additional embodiments, the sound absorbing features can have a depth and/or diameter of 20 μm, 40 μm, 60 μm, 100 μm, 0.1 mm, 0.3 mm 0.5 mm, 1.0 mm, 1.5 mm, 2.0 mm, etc., and can perforate through the entire thickness of the plate. In additional embodiments, holes or features in a plate can have varying depths or diameters, that is, each hole or feature in a plate can have a depth different or substantially the same as adjacent holes or features. FIG. 3A is an illustration of hole and etch variations according to some embodiments. With reference to FIG. 3A, holes or features according to some embodiments can having varying diameters through the depth of the hole or feature 32, 34 can terminate before perforating the panel 33, can vary between adjacent holes in a pattern 35, can be angled through the depth of the hole or feature 36, can be conical in shape (or other geometry) 37, or can form a throat 38. Such small, intricate features are difficult to produce using mechanical or laser machining processes especially for high volume production purposes requiring a high perforation ratio for large area coverage.

Exemplary embodiments can thus provide a smaller hole or perforation size to enable a thinner overall sound absorbing structure by reducing the cavity depth required for achieving high sound absorption. This advantage can save space in interior and exterior designs. For example, an exemplary acoustic dampening panel can employ friction by viscous airflow to dampen sound waves. This panel can comprise microperforations, e.g., holes through a panel (or portions thereof) whereby the holes have a diameter of less than 0.5 mm. A conventional microperforated panel (MPP) box (including the enclosed cavity) may be as wide as 100 mm; however, with the smaller perforation features enabled by the disclosed embodiments, e.g., on the order of about 20 to 50 μm, the required cavity depth between the panel and rear surface can be significantly reduced to about 10 to 20 mm thereby reducing the space required for acoustic dampening in architectural or other applications. Furthermore, such exemplary panels are not dependent on fiber materials. Applications of such sound absorbing panels include, but are not limited to, sound isolation of car engines, sound absorbing elements in buildings, interior or exterior spaces, among others.

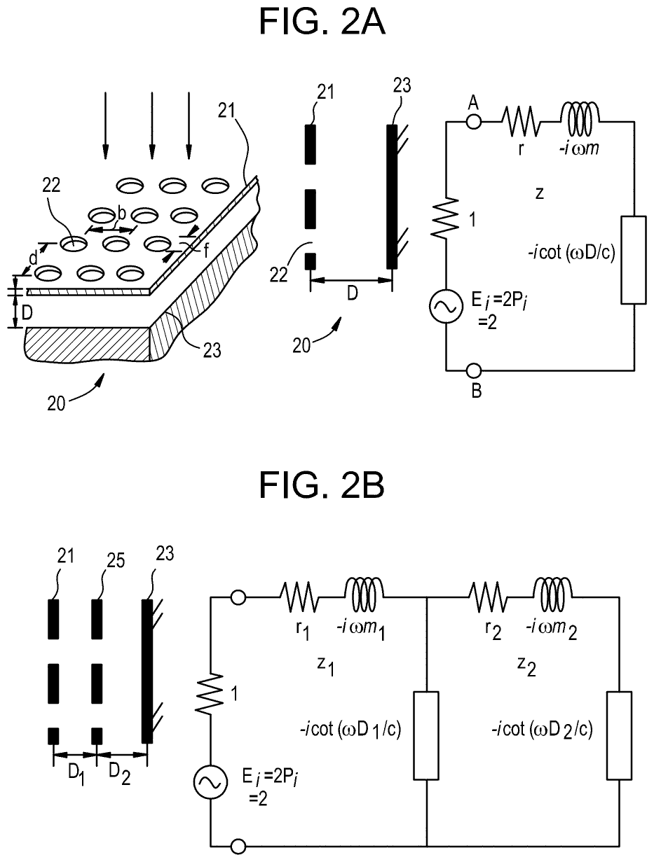

FIG. 2A is an exemplary microperforated panel (MPP) structure according to some embodiments and an equivalent circuit. With reference to FIG. 2A, an exemplary microperforated structure 20 includes a panel 21 having a thickness (t) and microperforations or holes 22 each with a diameter (d) and a spacing (b) therebetween. The holes 22 can be arranged at a distance or cavity depth (D) from a rear surface 23 with the perforated panel 21 facing a sound source P. Exemplary structures 20 and/or panels 21 can be formed from materials such as, but not limited to, sheet metal, plastic, plywood, acrylic, glass, glass ceramic, etc. The sound absorbing property of an exemplary MPP structure 20 can be determined by parameters thereof and properties of air. For example, the impedance of an MPP, z=r-iωm, is given by the following equations:

$$\begin{matrix}r = \frac{32 η}{ppc} \frac{t}{{d}^{2}} ( \sqrt{1 + \frac{{x}^{2}}{32}} + \frac{\sqrt{2}}{32} \times \frac{d}{t} ) & ( 1 ) \\ ω m = \frac{ω t}{pc} ( 1 + \frac{1}{\sqrt{1 + \frac{{x}^{2}}{2}}} + 0.85 \frac{d}{t} ) \\ where & ( 2 ) \\ x = \frac{d}{2} \sqrt{\frac{ρω}{η}} & ( 3 )\end{matrix}$$

and d, p, t represent the hole diameter, perforation ratio and thickness (e.g., throat length) of an MPP, respectively, h represents the coefficient of viscosity, r represents air density, c represents the speed of sound, and co represents the angular frequency of sound, where ω=2pf.

Some embodiments can include a single MPP and a rigid-back wall or substrate with an air cavity in-between (cavity depth of D) as depicted in FIG. 2A (left and center) which can then be modeled by an equivalent electrical circuit (FIG. 2A right). A series of Helmholtz resonators can thus be formed by the holes and the cavity. Other embodiments can include a second (or additional) panel(s) 25 to provide a double-leaf MPP absorber with a rigid-back wall to broaden the absorption range. In one non-limiting embodiment, two resonators can be formed as depicted in FIG. 2B (left) with its equivalent electrical circuit depicted in FIG. 2B (right).

It has also been discovered that the porosity or perforation ratio σ can be related to hole diameter (d) and spacing (b) using the following relationship:

$$σ = \frac{π \cdot {d}^{2}}{4 \cdot {b}^{2}} \qquad ( 4 )$$

It is known that conventional glass and glass ceramic materials have a sound absorption coefficient (σ) close to zero. This can lead to an excessively long reverberation time (RT) resulting in a loss of speech intelligibility and acoustic discomfort if too much glass is used in the planar or curved surfaces of a room, hall, etc. Using Sabine's formula relating sound absorption α to RT₆₀, the time required for reflections of a direct sound to decay 60 dB can be determined using the following relationship:

$${RT}_{60} = 0.161 \frac{V}{{\sum }_{i} {α}_{i} \cdot {S}_{i}} \qquad ( 5 )$$

where V represents the volume of room or space, and αᵢ and Sᵢ represent the sound absorption coefficient of a surface and the surface area, respectively.

By utilizing embodiments of the present disclosure described herein, an exemplary glass, glass ceramic or other material surface can be made into a highly acoustic-absorptive apparatus. The acoustic absorption (α) of an exemplary MPP (having a thickness (t), holes with diameter (d), cavity depth (D) and spacing (b) therebetween, see, e.g., FIGS. 2A-2B) structure can thus be modeled and described using Equations (1)-(3) and the relationship:

$$α = \frac{4 r}{{( 1 + r )}^{2} + {( ω m - cot ( ω D \text{/} c ) )}^{2}} \qquad ( 6 )$$

While FIG. 2A-2B illustrate a symmetrical pattern of cylindrical holes 22, the claims appended herewith should not be so limited as the shape, size, distribution, number, configuration, etc. of holes or features can be a function of mask design and/or the application of the respective MPP structure. FIG. 3B provides exemplary, non-limiting mask designs 30a, 30b, 30c, 30d where different size, shape, distribution of the micro-holes can be designed to suit functional and/or aesthetic requirements of a user. With reference to FIG. 3B, a mask design can include cylindrical holes each having a substantially similar diameter and symmetrically arranged by row and column 30a, cylindrical holes each having a substantially similar diameter and arranged by row and offset by column 30b, star-shaped holes each having similar dimensions and arranged by row and offset by column 30c, star-burst forms having dissimilar dimensions and asymmetrically arranged 30d, etc. Of course, these mask designs and subsequent hole or feature arrangements are exemplary only and should not limit the scope of the claims appended herewith as the size, shape and distribution of the holes can be functionally or aesthetically suitable to the acoustic and/or aesthetic requirements of a user. Thus, any arbitrary shapes or combination of different shapes of the micro-features and arbitrary distributions of such features in a surface can be possible and are envisioned. Such intricate features as shown in FIGS. 3A and 3B can be conveniently translated to a photosensitive glass, glass ceramic, or other material plate via the UV exposure process, followed by an exemplary chemical etching process as described above.

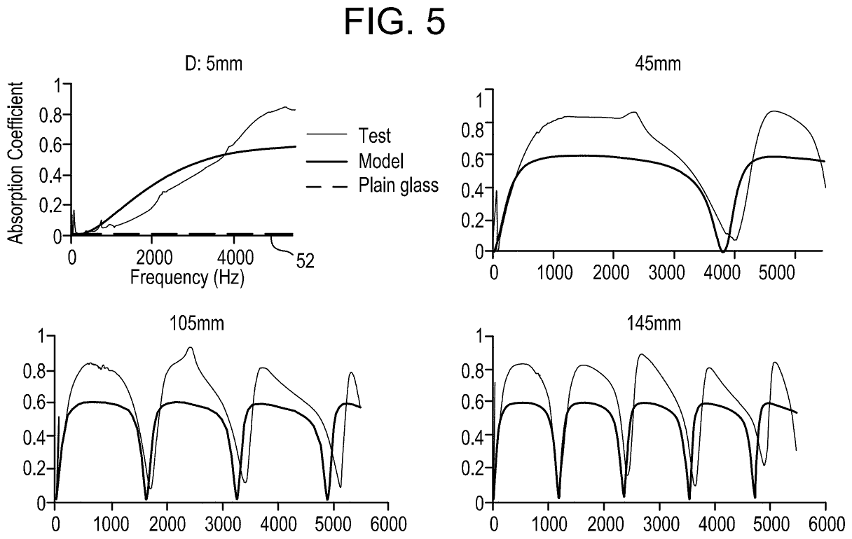

FIGS. 4A and 4B are photographs of a microperforated sample according to some embodiments. With reference to FIG. 4A, a disk-shaped microperforated sample 40 is illustrated having a plurality of sets 42 of cylindrical holes or features symmetrically arranged by row and column. FIG. 4B is a microscopic view of the features 44 in a set illustrated in FIG. 4A. The material employed was a photosensitive material having a composition include between about 75-85 wt % SiO₂, about 2-6 wt % Al₂O₃, about 7-11 wt % Li₂O, about 3-6 wt % K₂O, about 0.5-2.5 wt % Na₂O, about 0.01-0.5 wt % Ag, about 0.01-0.5 wt % Sb₂O₃, about 0.01-0.04 wt % CeO₂, about 0-0.01 wt % Au, and about 0-0.01 wt % SnO₂. The microperforated sample 40 included through holes 44 having a diameter of about 100 μm and a spacing between adjacent holes of about 200 μm.

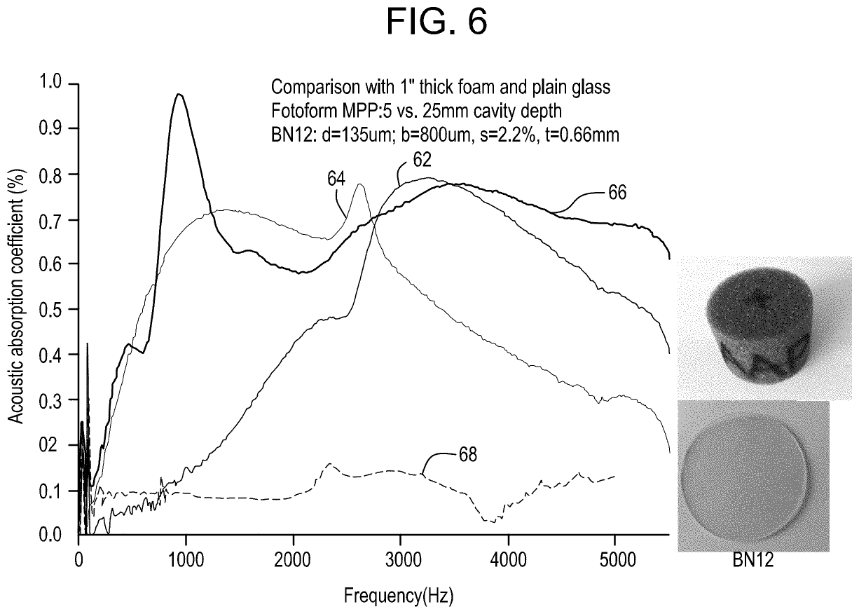

The MPP structure depicted in FIGS. 4A and 4B was then tested using an acoustic impedance tube for sound absorption measurement. FIG. 5 is a series of plots illustrating acoustic absorption of some embodiments. With reference to FIG. 5, the experimental results for cavity depths (D) of 5 mm, 45 mm, 105 mm and 145 mm were measured utilizing the MPP structure of FIGS. 4A and 4B and are graphically illustrated. As is readily observed, each embodiment provides noticeable improvements to acoustic absorption over that of a glass sheet 52.

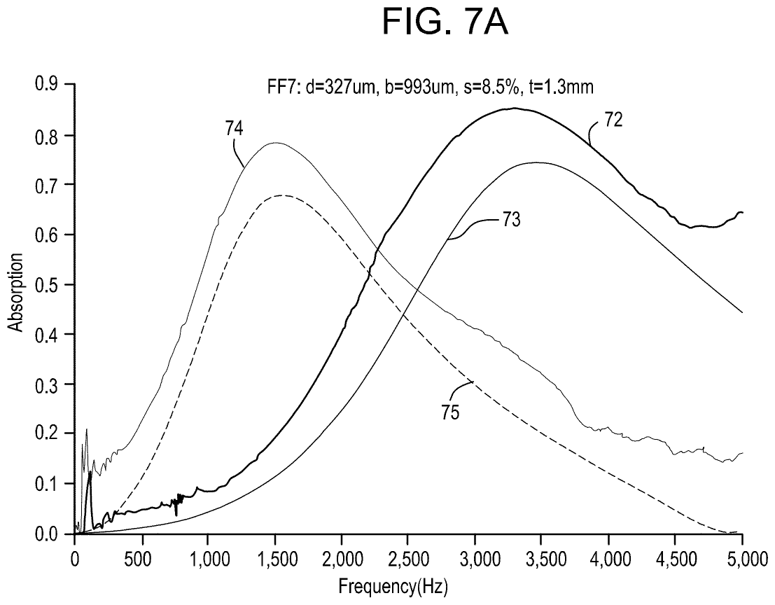

FIG. 6 is a plot of measured acoustic absorption between some embodiments, conventional glass and one inch foam. With reference to FIG. 6, the acoustic absorption of an exemplary MPP structure 62 having a distance d between adjacent holes of 135 μm, plate thickness t about 0.66 mm, and a cavity depth D of 5 mm, an exemplary MPP structure 64 having a distance d between adjacent holes of 135 μm, plate thickness t about 0.66 mm, and a cavity depth D of 25 mm were measured and compared with the acoustic absorption of a one inch foam core 66 and a sheet of conventional glass 68. It was observed that conventional glass has very low absorption, while both exemplary MPP structures provide a broadband and comparable absorption as the foam core.

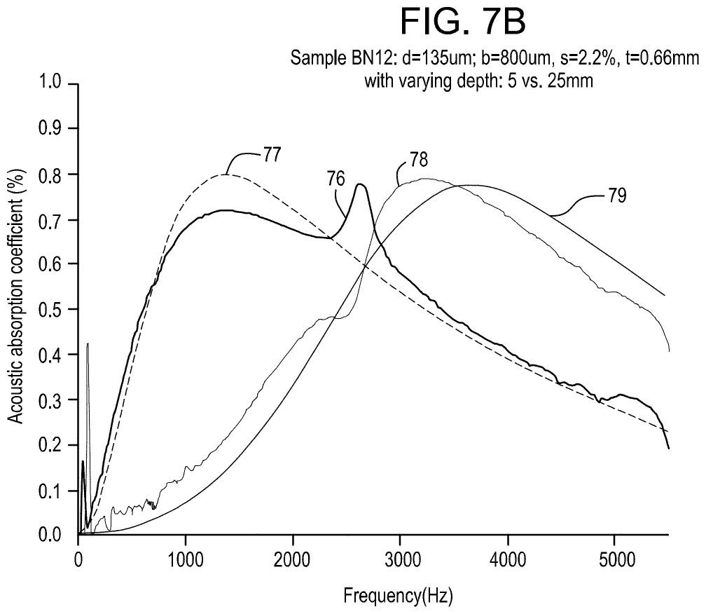

FIGS. 7A and 7B are plots comparing experimental measurements of two embodiments with theoretical models. With reference to FIG. 7A, acoustic absorption of an exemplary MPP structure 72 having a cavity depth D of 10 mm, plate thickness t about 1.3 mm and an exemplary MPP structure 74 having a cavity depth D of 35 mm and plate thickness t about 1.3 mm were compared with the model-predicted acoustic absorption of the same structures 73, 75, respectively. It can be observed that the measured and model-predicted acoustic absorption of the two different MPP structures were in agreement. With reference to FIG. 7B, acoustic absorption of an exemplary MPP structure 76 having a cavity depth D of 25 mm, plate thickness t about 0.66 mm and an exemplary MPP structure 78 having a cavity depth D of 5 mm and plate thickness t about 0.66 mm were compared with the model-predicted acoustic absorption of the same structures 77, 79, respectively. It can again be observed that the measured and model-predicted acoustic absorption of the two different MPP structures were in agreement.

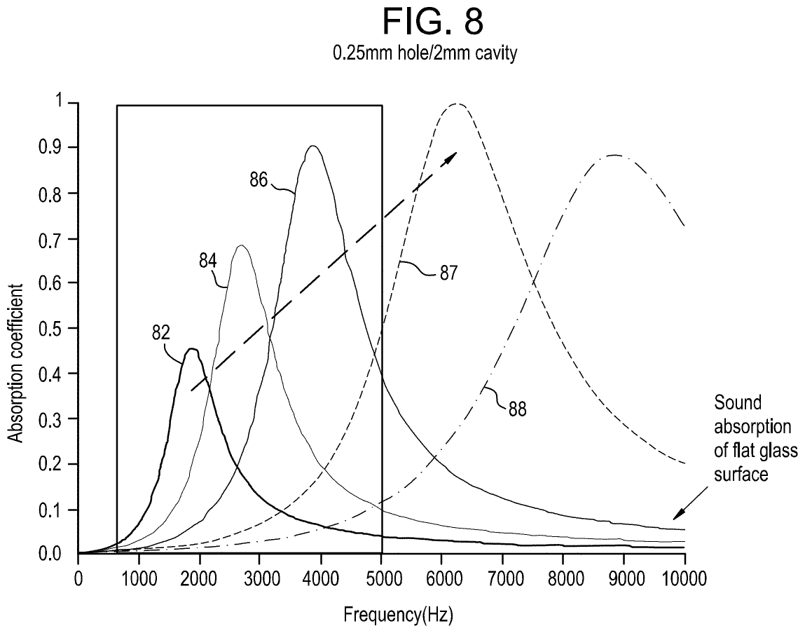

FIG. 8 is a plot comparing measurements of acoustic absorption of additional embodiments as a function of perforation ratio. With reference to FIG. 8, acoustic absorption of exemplary MPP structures having a hole diameter of 0.25 mm and fixed cavity depth D of 2 mm were measured from a 0.25% perforation ratio 82, to a 0.5% perforation ratio 84, a 1% perforation ratio 86, a 2.5% perforation ratio 87, and a 5% perforation ratio 88. As illustrated in FIG. 8, an impact of increasing perforation ratio from 0.25% to 5% on sound absorption of a MPP structure can be markedly observed.

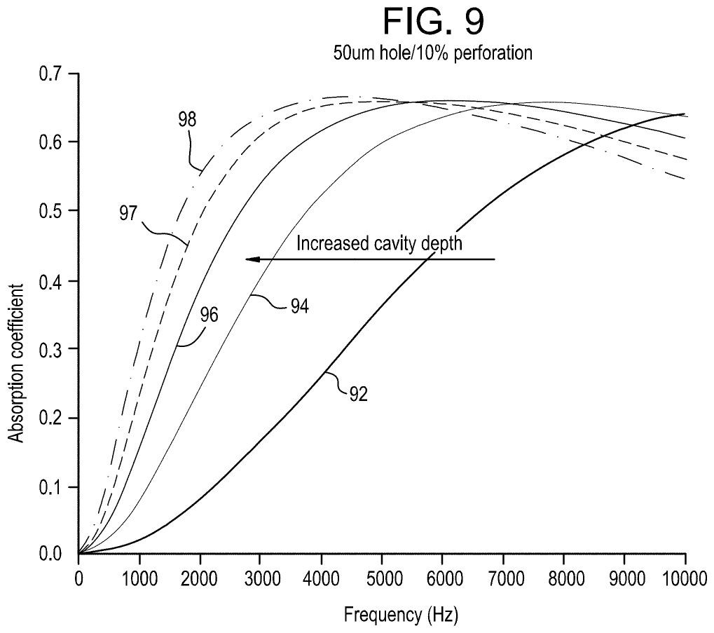

FIG. 9 is a plot comparing measurements of acoustic absorption of further embodiments as a function of cavity depth. With reference to FIG. 9, acoustic absorption of exemplary MPP structures having a hole diameter of 50 μm and a fixed perforation ratio of 10% were measured with a cavity depth D of 2 mm 92, a cavity depth D of 4 mm 94, a cavity depth D of 6 mm 96, a cavity depth D of 8 mm 97, and a cavity depth D of 10 mm 98. As illustrated in FIG. 9, an impact of increasing cavity depth from 2 mm to 10 mm for a fixed diameter 50 μm hole can be markedly observed. Thus, it follows that embodiments described herein can be optimally designed for the application required, e.g., acoustic absorption requirements vs. optical transparency and/or visual impact of the hole patterns based on a multi-variable (d, b or σ, t, D) design approach.

Some embodiments can thus be employed to dissipate or convert acoustical energy into heat. In these embodiments, sound waves propagate into an exemplary panel and because of the proximity of the panel to a rear surface, oscillating air molecules inside the structure lose their acoustical energy due to friction between the air in motion and the surface of the MPP. Additional embodiments can also be tuned by hole geometry and distribution, as well as the air gap (cavity depth) behind the panel as described above. Thus, by varying geometrical and material parameters, the acoustical performance of some embodiments can be tailored to meet a multitude of specifications in various applications.

Exemplary embodiments can thus provide a pristine, smooth and hard surface of glass that is highly desirable in architectural and interior design and can be sound absorbing. Embodiments can be transparent for lighting, durable, scratch and soil resistant and can be aesthetically appealing while having low sound absorption—a characteristic which is uncommon in a material (e.g., glass) known for its intrinsic near-zero sound absorption and large excessive reverberation time (RT). Conventional glass finds limited use in enclosed spaces such as classrooms, offices, conference rooms, patient wards and elevator cabins due to such large RT; however, exemplary embodiments as described herein can be employed to balance acoustics and provide the aesthetic appeal requested by architects, designers, and residents alike.

While embodiments have been described as including photosensitive glass, the claims appended herewith should not be so limited as it is envisioned that transparent, substantially transparent, opaque, and/or colored acrylics, glass-ceramics, and polymers can be employed as an exemplary panel and are suitable with the described processes. Furthermore, while some embodiments have been described as having flat panel shapes and specific distributions (e.g., holes in certain patterns), the claims appended herewith should not be so limited as embodiments can be flat or curved (e.g., three dimensional) and can have slits, ridges, channels or other patterns (symmetrical or asymmetrical) depending on the type or types of mask(s) employed. Thus, embodiments can eliminate the need for mechanical or laser drilling process currently used in making sound absorbers and can be shaped in three dimensions to suit any respective design and application needs.

Embodiments described herein can also employ a photosensitive substrate material and can be formed with a mask design having micro-features or patterns that can produce the required or desired acoustic absorption in a microperforated panel structure. Exemplary embodiments made of photosensitive glass, glass ceramics or other materials can be further decorated using printing technology to add further design appeals. Different native colors of the panel are also possible through heat treatment and material composition design.

In some embodiments a method of making a sound absorbing panel is provided. The method can include providing a first sheet of photosensitive material, applying a first mask having a first plurality of features to the first sheet of photosensitive material, and exposing the masked material to ultraviolet light. In some embodiments, the step of providing a first sheet of photosensitive material can include the steps of melting the glass and casing the molten glass into thin sheet. The method also includes heating the first sheet of photosensitive material to form crystals in exposed portions of the first sheet and etching the crystals to form a second plurality of features in the first sheet of photosensitive material. In a further embodiment this method can include repeating these steps for a second sheet of photosensitive material. In further embodiments, a resilient surface spaced apart from and substantially in the same shape of the first or second sheet of photosensitive material can be provided wherein the first and second sheets of photosensitive material are between the resilient surface and environment. In some embodiments, the second plurality of features is substantially similar to the first plurality of features. In another embodiment, the method includes applying a second mask having a third plurality of features to the etched first sheet of photosensitive material, exposing the masked material to ultraviolet light, heating the first sheet of photosensitive material to form crystals in exposed portions of the first sheet, and etching the crystals to form a fourth plurality of features in the first sheet of photosensitive material. In some embodiments, the fourth plurality of features is substantially similar to the first plurality of features. The sheets of materials described herein can be planar or three dimensional. In some embodiments, the method can include bending the first sheet of photosenstive material before the step of applying the mask or after the step of etching the crystals. Exemplary photosensitive material can be, but are not limited to, a glass or glass ceramic material. In some embodiments, the first sheet photosensitive material can comprise about 75-85 wt % SiO₂, about 2-6 wt % Al₂O₃, about 7-11 wt % Li₂O, about 3-6 wt % K₂O, about 0.5-2.5 wt % Na₂O, about 0.01-0.5 wt % Ag, about 0.01-0.5 wt % Sb₂O₃, about 0.01-0.04 wt % CeO₂, about 0-0.01 wt % Au, and about 0-0.01 wt % SnO₂. In a further embodiment, the method can include tinting, coloring or decorating the first sheet of photosensitive material. The sheets of photosensitive material can also be strengthened if necessary. The features provided in the sheet can have a diameter or depth of up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm.

In other embodiments a sound absorbing panel is provided having a first sheet of photosensitive material and a resilient surface spaced apart from the first sheet of photosensitive material by a predetermined distance. The sheet of photosensitive material includes a first plurality of features etched therein, and the dimensions and distribution of the first plurality of features and the predetermined distance are determined as a function of sound aborptive characteristics of the panel. In some embodiments, the etched features can be formed by applying a mask having the plurality of features therein to the first sheet of photosensitive material, exposing the masked material to ultraviolet light, heating the material glass to form crystals in the exposed glass, and etching the crystals to form the plurality of features in the first sheet of material. In other embodiments, the first sheet of material is three dimensional. Exemplary photosensitive material can be, but are not limited to, a glass or glass ceramic material. In some embodiments, the first sheet photosensitive material can comprise about 75-85 wt % SiO₂, about 2-6 wt % Al₂O₃, about 7-11 wt % Li₂O, about 3-6 wt % K₂O, about 0.5-2.5 wt % Na₂O, about 0.01-0.5 wt % Ag, about 0.01-0.5 wt % Sb₂O₃, about 0.01-0.04 wt % CeO₂, about 0-0.01 wt % Au, and about 0-0.01 wt % SnO₂. Exemplary thicknesses of the sheets can be, but are not limited to, up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm. The photosenstive material can be translucent, transparent, tinted, colored, or decorated and can also be strengthened. The features provided in the sheet can have a diameter or depth of up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm. In another embodiment, the panel includes a second sheet of photosensitive material having a second plurality of features etched therein, the second sheet intermediate the first sheet and the resilient surface.

In further embodiments, a sound absorbing panel is provided comprising a first sheet of photosensitive material and a resilient surface spaced apart from the first sheet of photosensitive material by a predetermined distance. The first sheet of photosensitive material can include a plurality of features formed therein without mechanical etching. In some embodiments, the etched features can be formed by applying a mask having the plurality of features therein to the first sheet of photosensitive material, exposing the masked material to ultraviolet light, heating the material glass to form crystals in the exposed glass, and etching the crystals to form the plurality of features in the first sheet of material. In other embodiments, the first sheet of material is three dimensional. Exemplary photosensitive material can be, but are not limited to, a glass or glass ceramic material. In some embodiments, the first sheet photosensitive material can comprise about 75-85 wt % SiO₂, about 2-6 wt % Al₂O₃, about 7-11 wt % Li₂O, about 3-6 wt % K₂O, about 0.5-2.5 wt % Na₂O, about 0.01-0.5 wt % Ag, about 0.01-0.5 wt % Sb₂O₃, about 0.01-0.04 wt % CeO₂, about 0-0.01 wt % Au, and about 0-0.01 wt % SnO₂. Exemplary thicknesses of the sheets can be, but are not limited to, up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm. The photosenstive material can be translucent, transparent, tinted, colored, or decorated and can also be strengthened or, specifically, chemically strengthened or thermally strengthened. The features provided in the sheet can have a diameter or depth of up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm. In another embodiment, the panel includes a second sheet of photosensitive material having a second plurality of features etched therein, the second sheet intermediate the first sheet and the resilient surface.

While this description can include many specifics, these should not be construed as limitations on the scope thereof, but rather as descriptions of features that can be specific to particular embodiments. Certain features that have been heretofore described in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and can even be initially claimed as such, one or more features from a claimed combination can in some cases be excised from the combination, and the claimed combination can be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing can be advantageous.

As shown by the various configurations and embodiments illustrated in FIGS. 1-9, various embodiments for transparent sound absorbing panels have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof

What is claimed is:

1. A sound absorbing panel comprising:
a first sheet of photosensitive material; and
a resilient surface spaced apart from the first sheet of photosensitive material by a predetermined distance,
wherein the sheet of photosensitive material includes a first plurality of features.

2. The sound absorbing panel of claim 1, wherein the first plurality of features comprise etched features.

3. The sound absorbing panel of claim 1, wherein the first sheet of material is three dimensional.

4. The sound absorbing panel of claim 1, wherein the photosensitive material is a glass or glass ceramic material.

5. The sound absorbing panel of claim 1, wherein the photosensitive material comprises:
about 75-85 wt % SiO₂,
about 2-6 wt % Al₂O₃,
about 7-11 wt % Li₂O,
about 3-6 wt % K₂O,
about 0.5-2.5 wt % Na₂O,
about 0.01-0.5 wt % Ag,
about 0.01-0.5 wt % Sb₂O₃,
about 0.01-0.04 wt % CeO₂,
about 0-0.01 wt % Au, and
about 0-0.01 wt % SnO₂.

6. The sound absorbing panel of claim 1, wherein the first sheet has a thickness of up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm.

7. The sound absorbing panel of claim 1, wherein the photosenstive material is translucent, transparent, tinted, colored, or decorated.

8. The sound absorbing panel of claim 1, wherein the photosensitive material is strengthened.

9. The sound absorbing panel of claim 1, wherein the features have a diameter or depth of up to about 20 μm, up to about 40 μm, up to about 60 μm, up to about 100 μm, up to about 0.1 mm, up to about 0.3 mm, up to about 0.5 mm, up to about 1.0 mm, up to about 1.5 mm, or up to about 2.0 mm.

10. The sound absorbing panel of claim 1 further comprising a second sheet of photosensitive material having a second plurality of features etched therein, the second sheet intermediate the first sheet and the resilient surface.

11. A sound absorbing panel comprising:
a first sheet of photosensitive material; and
a resilient surface spaced apart from the first sheet of photosensitive material by a predetermined distance,
wherein the first sheet of photosensitive material includes a plurality of features formed therein without mechanical etching.

12. The sound absorbing panel of claim 11 wherein the plurality of features are formed by chemical etching.

13. The sound absorbing panel of claim 11, wherein the first sheet of material is three dimensional.
